(19) United States
(12) Patent Application Publication
(10) Pub. No.: US 2017/0112317 A1
(43) Pub. Date: Apr. 27, 2017

(54) PRESSURIZED BEVERAGE MAKER

(71) Applicant: Wang WANG, Edmonton (CA)

(72) Inventor: Wang WANG, Edmonton (CA)

(21) Appl. No.: 14/923,768

(22) Filed: Oct. 27, 2015

(51) Int. Cl. A47J 31/02; A47J 31/06; A47J 31/44

(52) U.S. Cl. CPC A47J 31/02; A47J 31/44; A47J 31/0668

(57) ABSTRACT

A manually operated beverage maker and dispenser includes: a receptacle having an upper opening; a manually operable air pump separate from and attached to the receptacle; and an air passage from the air pump to the receptacle. The air passage is equipped with one-way valve for permitting air to pass from the air pump to the receptacle while preventing flow of fluids from the receptacle towards the air pump.

### FIELD OF THE INVENTION

The present invention relates to a device for making or filtering a beverage, and in particular, for brewing coffee or tea.

### BACKGROUND

Many beverages are made by infusing water through solids such as coffee grounds or tea leaves. It is desirable to separate the solids from the beverage, which is conveniently accomplished with filters or screens. However, the solids may clog the filter and the beverage may take a long time to pass through the filter.

In some instances, it may be desirable to pressurize the beverage so that it passes through the filter more quickly.

### SUMMARY OF THE INVENTION

The present invention provides a convenient, manually operated device to make a beverage by filtering solids from the beverage. No external power source or pressurized fluid source is required.

In one aspect, the invention may comprise a beverage maker and dispenser, comprising
(a) a receptacle having an upper opening;
(b) a manually operable air pump separate from and attached to the receptacle;
(c) an air passage from the air pump to the receptacle, comprising a first one-way valve for permitting air to pass from the air pump to the receptacle the receptacle while preventing flow of fluids from the receptacle towards the air pump.
   In one embodiment, the air passage comprises a transverse air passage tube and the air pump forms a handle of the receptacle.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1 shows one embodiment of the present invention in a first stage of use.

FIG. 2A shows the embodiment of FIG. 1 in a second stage of use. FIG. 2B shows an alternative configuration of the air pump.

FIG. 3 shows an alternative embodiment comprising an accessory.

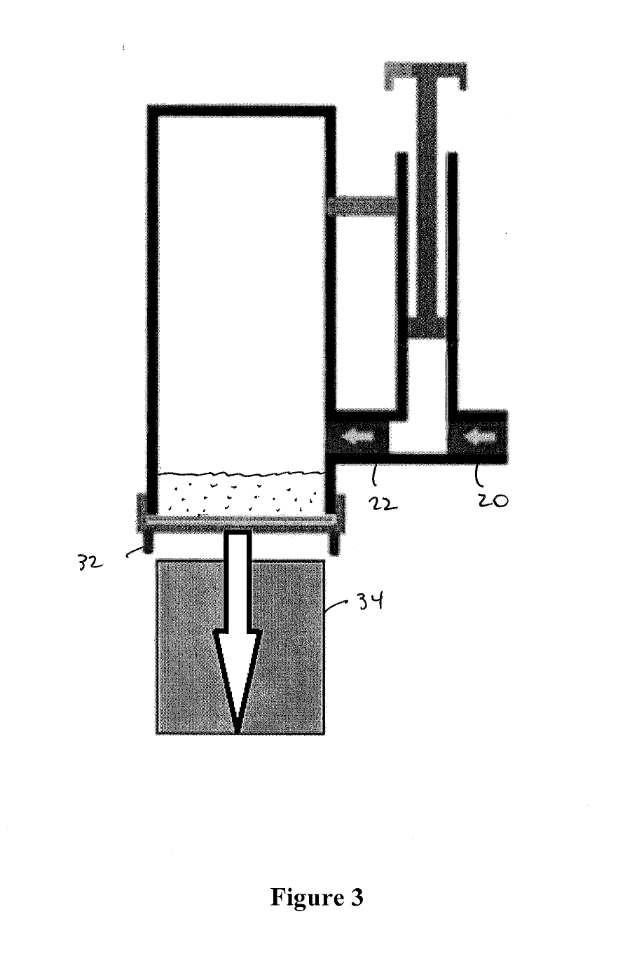

FIG. 4 shows an alternative embodiment of an accessory unit which adapts the use of a pre-packaged coffee pod.

FIG. 5 shows an alternative embodiment comprising a support flange which allows the device to rest on a mug.

### DETAILED DESCRIPTION

In one embodiment, the present invention comprises a beverage making device (10) comprising a receptacle (12) having an upper opening (14) and a separate but attached air pump (16). An air passage (18) connects the air pump to the receptacle and includes a one-way valve (22) which permits air to be pumped into the receptacle, while the opposite flow of fluids from the receptacle is prevented. A second intake one-way valve (20) for allowing the air pump to be filled with air may be positioned leading to the air outlet (24) into the receptacle. In an alternative embodiment, the intake one-way valve (20) may be included in the air pump (16) or piston (30) itself, and may not be necessary in the air passage (18). What is necessary is that the air pump (16) draw in air from outside the device, and when actuated, the air pump (16) discharges air into the receptacle (12).

In one embodiment, the air passage (18) may be a transverse air passage tube which connects the air pump (16) to the receptacle (12), while holding the air pump (16) apart from the receptacle (12). In this fashion, the air pump (16) may serve as a handle for the device. In one embodiment, a lower connector (26) may more securely attach the air pump (16) to the receptacle, to reduce the physical stress on the transverse air passage (18).

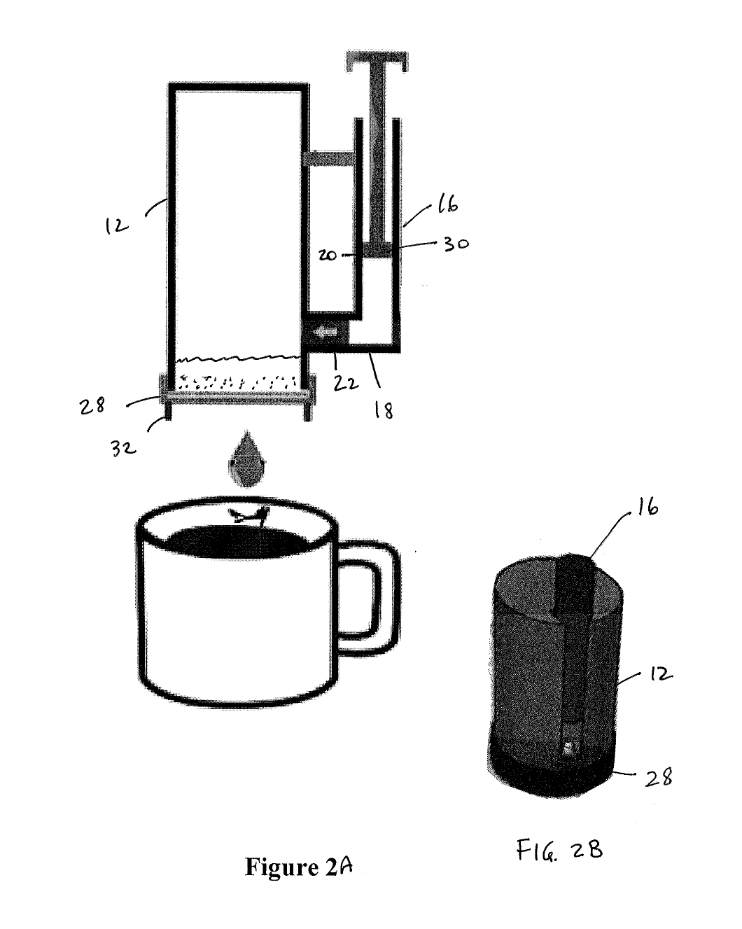

In an alternative embodiment, the air pump (16) may be closely integrated with the receptacle (12), as is shown in FIG. 2B. The air pump (16) is separate from receptacle, but is physically integrated into the receptacle.

In any example, the air pump (16) may comprise any device which pumps air in one direction, such as a pump including a reciprocating plunger within an elongated cylinder, a flexible bladder pump, or a rotating vane or impeller pump.

A filter assembly (28) is configured to securely attach to and cover the upper opening. In one embodiment, the filter (28) may comprise a reinforcing screen and a filter element, such as a disposable paper element. In another embodiment, the filter (28) may comprise a reusable fine metal or plastic mesh. The filter fits securely to the receptacle (12) such as by friction fit, or by a threaded connection, or some other physical connection. In one embodiment, the filter may be sufficiently restrictive as to substantially prevent the beverage from passing through the filter when the device is oriented with the filter assembly (28) at the bottom, in the absence of pressure from within the receptacle (12).

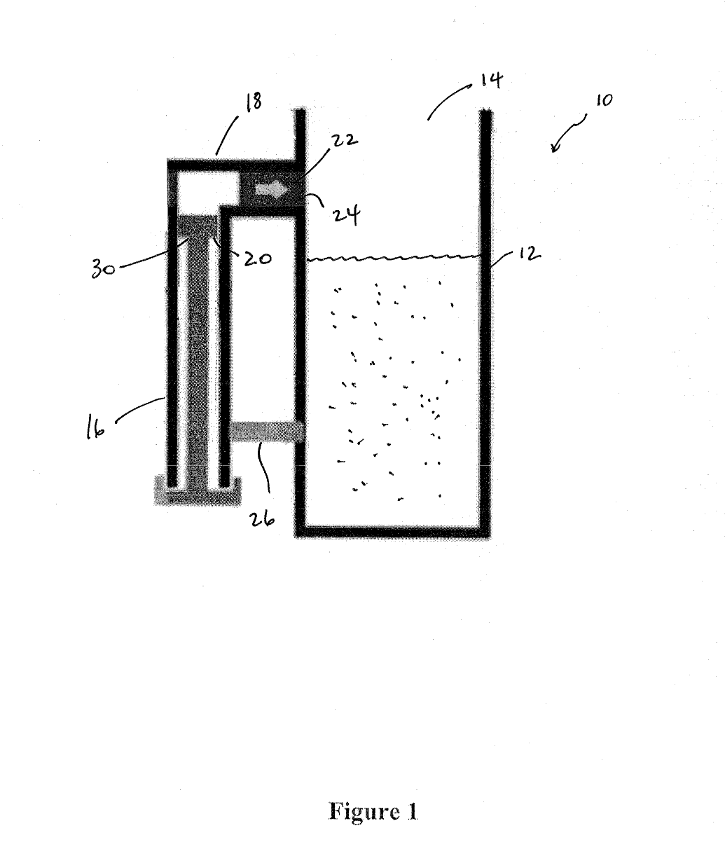

In use, the receptacle (12) is filled with the solid material with which the beverage is made, such as coffee grounds or tea leaves, and hot water, as shown in FIG. 1, or only water or some other liquid in some examples. The air pump (16) is fully retracted in that the piston (30) is at its upper end of travel. In such a configuration, the receptacle may sit stably on a flat surface as the air pump does not extend beyond the height of the receptacle. Once the beverage is ready to be dispensed or consumed, the device is turned upside down above a beverage mug or glass, and the air pump (16) is primed by withdrawing the piston (30), such that air enters the air pump, The piston (30) can then be activated to push air into the receptacle (12) through valve (22). The beverage is then pushed out by the elevated pressure in the receptacle, through the filter (28) and into the beverage mug or glass.

In one alternative embodiment, the filter assembly (28) is adapted with accessory mounts (32) which permits the attachment of an accessory unit (34). For example, the accessory mounts (32) and the accessory unit (34) may have complementary threads so as to allow them to be threaded together, or some other attachment mechanism which allows convenient attachment and disengagement.

In one embodiment, the accessory unit may comprise a water purification module or a pre-packaged beverage mix, such as a single use coffee pod. Water purification modules may comprise activated charcoal filters and/or purification membranes or filters. As is known in the art, a single use coffee pod comprises coffee grounds packaged in a small pod which filters the coffee as water passes through the pod, and includes K-Cups™ and other commercially available pods. In such an alternative embodiment, the filter assembly (28) need not necessarily include a screen or filter, as the filter element may be included in the accessory unit. Alternatively, the filter assembly (28) itself may comprise the purification filter or membrane, or include the beverage making solid.

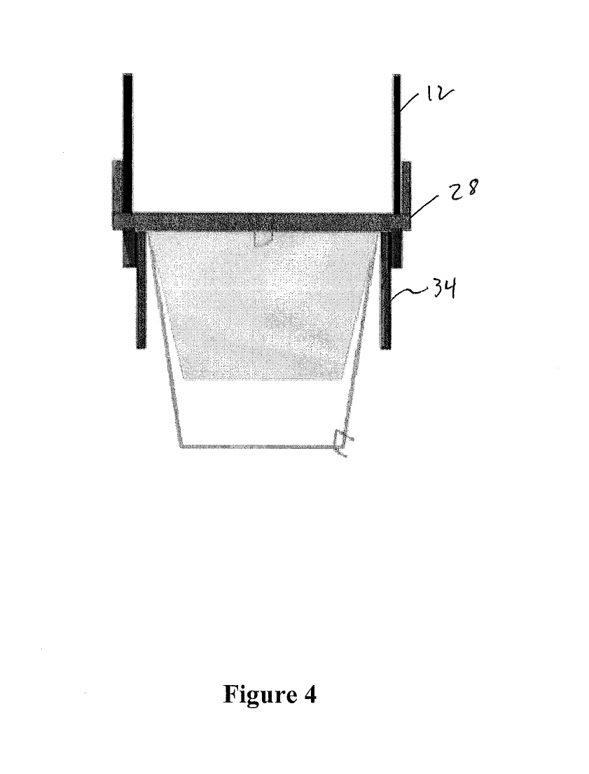

In one embodiment, as shown in FIG. 4, the accessory unit (34) comprises a K-Cup™ adapter which holds the rigid plastic K-Cup up against the filter assembly (28). Any cuts or openings to the pod required may be manually made before use.

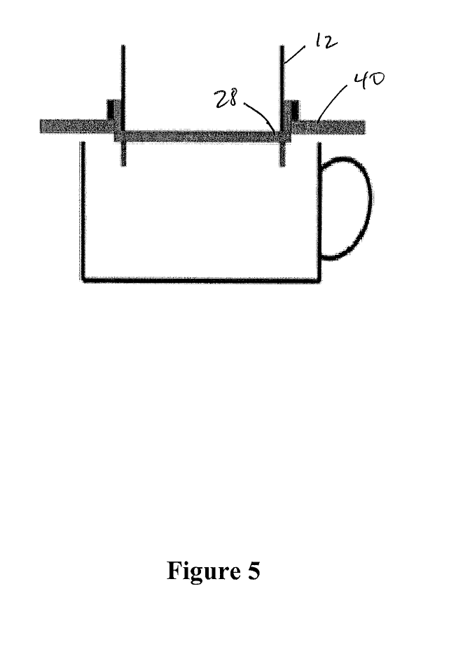

In one embodiment, as shown in FIG. 5, the filter assembly may support or include a member, such as a supporting circumferential flange (40), which allows the device to stably rest on top of a mug.

The present invention is not intended to be limited by the type of beverage which it may dispense. The beverage may simply be water which is filtered by the device (10). The device may be used to make any beverage which is made with or from any solid material, such as coffee, tea, herbal drinks or medications and the like.

### DEFINITIONS AND INTERPRETATION

The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. Embodiments were chosen and described in order to best explain the principles of the invention and the practical application, and to enable others of ordinary skill in the art to understand the invention for various embodiments with various modifications as are suited to the particular use contemplated.

The corresponding structures, materials, acts, and equivalents of all means or steps plus function elements in the claims appended to this specification are intended to include any structure, material, or act for performing the function in combination with other claimed elements as specifically claimed.

References in the specification to “one embodiment”, “an embodiment”, etc., indicate that the embodiment described may include a particular aspect, feature, structure, or characteristic, but not every embodiment necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to combine, affect or connect such aspect, feature, structure, or characteristic with other embodiments, whether or not such connection or combination is explicitly described. In other words, any element or feature may be combined with any other element or feature in different embodiments, unless there is an obvious or inherent incompatibility between the two, or it is specifically excluded.

It is further noted that the claims may be drafted to exclude any optional element. As such, this statement is intended to serve as antecedent basis for the use of exclusive terminology, such as “solely,” “only,” and the like, in connection with the recitation of claim elements or use of a “negative” limitation. The terms “preferably,” “preferred,” “prefer,” “optionally,” “may,” and similar terms are used to indicate that an item, condition or step being referred to is an optional (not required) feature of the invention.

The singular forms “a,” “an,” and “the” include the plural reference unless the context clearly dictates otherwise. The term “and/or” means any one of the items, any combination of the items, or all of the items with which this term is associated.

What is claimed is:

1. A beverage maker and dispenser, comprising:
(a) a receptacle having an upper opening;
(b) a manually operable air pump separate from and attached to the receptacle;
(c) an air passage from the air pump to the receptacle, comprising a first one-way valve for permitting air to pass from the air pump to the receptacle while preventing flow of fluids from the receptacle towards the air pump.

2. The beverage maker and dispenser of claim 1 wherein the air pump is attached to the receptacle by a transverse air passage, the air pump being spaced apart from the receptacle to form a handle.

3. The beverage maker and dispenser of claim 1 wherein the air pump is elongate and cylindrical.

4. The beverage maker and dispenser of claim 1 further comprising a filter assembly adapted to fit into or over the upper opening.

5. The beverage maker and dispenser of claim 4 wherein the filter assembly comprises an accessory mount.

6. The beverage maker and dispenser of claim 5 further comprising a purification module accessory or a pre-packaged beverage mix.

7. The beverage maker and dispenser of claim 6 wherein the pre-packaged beverage mix comprises a single use coffee pod.

8. The beverage maker and dispenser of claim 4 wherein the filter assembly comprises a pre-packaged beverage mix.

9. The beverage maker and dispenser of claim 4 wherein the filter assembly comprises a member for supporting the dispenser on a mug or cup.
